(19) United States
(12) Patent Application Publication
(10) Pub. No.: US 2023/0266281 A1
(43) Pub. Date: Aug. 24, 2023

(54) HIGH THROUGHPUT LIQUID CHROMOTOGRAPHY USING LOW FLOWRATE

(71) Applicant: Brigham Young University, Provo, UT (US)

(72) Inventors: Xiaofeng Xie, Provo, UT (US); Ryan Thomas Kelly, Mapleton, UT (US)

(21) Appl. No.: 18/174,450

(22) Filed: Feb. 24, 2023

Related U.S. Application Data
(60) Provisional application No. 63/313,543, filed on Feb. 24, 2022.

(51) Int. Cl. G01N 30/34; G01N 30/32; G01N 30/72

(52) U.S. Cl. CPC G01N 30/34; G01N 30/32; G01N 30/7233; G01N 2030/326; G01N 2030/328; G01N 2030/324; G01N 2030/027

(57) ABSTRACT

A high-duty-cycle liquid chromatography system that includes two or more columns that are configured to alternatingly be in a productive phase or a regeneration phase, wherein simultaneously one of the columns is in a productive phase and the other columns are in the regeneration phase. Additionally, the system includes a mobile phase gradient delivery pump, an isocratic pump, two or more gradient storage chambers, and two or more valves that are each independently coupled to a column and a gradient storage chamber. The column in the productive phase has a solution containing a sample which is pushed through the column, collected at a detector, and analyzed. The column in the regeneration phase is being prepared for the next productive phase.

### CROSS-REFERENCE TO RELATED APPLICATIONS

This application claims the benefit of and priority to U.S. Provisional Application No. 63/313,543 filed on Feb. 24, 2022, the entire content of which is incorporated herein by reference.

### BACKGROUND

Liquid chromatography is an analytical chemistry technique used in the process of separating components in a mixture allowing the individual components to be identified and quantified. While the productive portion of liquid chromatography, where the analytes of interest are eluted, can be a slow process, the productive portion is only a fraction of the overall process of liquid chromatography. Additionally, the overall process includes loading the sample, column washing and regeneration, and dead time.

Liquid chromatography is commonly coupled to a mass spectrometer (MS, or mass spec) to perform the identification and quantification aspects of the process. An MS may be a limiting cost of a research budget, costing in some cases several hundreds of thousands of dollars, or even a million or more dollars. Thus, the need for productivity is high in order to meet cost/benefit. Unfortunately, the use of such devices, particularly those implementing lower flow rate methods, such as is common in biotechnology applications, can waste significant costs each day while the machine(s) idle during the non-productive, regenerative steps. Low flow rates may be important in some cases to enhance sensitivity of the instrumentation. Low flow rates, however, can result in a low duty cycle, which spreads out the times during which a column may be used for production.

Moreover, this low duty cycle can leave an expensive mass spectrometer that depreciates at a rate of hundreds of dollars per day sitting idle for more than half the time. Duty cycle tends to decrease in the low-nanoflow regime that is optimal for proteomic analysis, as the slow flow rates lead to long sample loading and transit times through connecting tubing.

To address these challenges, conventional systems may increase operating pressures and flow rate, however, this can lower the overall sensitivity, and thus may result in a loss of performance. Other solutions include multiple liquid chromatography machines which allow multiple samples to run, however, an extra liquid chromatography or an extra mass spec machine can be cost prohibitive, not to mention taking up precious laboratory space.

Therefore, there are a number of disadvantages in the art that can be addressed.

### BRIEF SUMMARY

Embodiments described herein are related to systems and methods for performing high-duty-cycle liquid chromatography with low flow rate, thereby allowing for improved sensitivity while minimizing regenerative downtime. In one example, the high-duty-cycle liquid chromatography system is configured to increase the amount of samples being analyzed by a detector while still maintaining a low flow rate resulting in an increased speed of the overall liquid chromatography process by parallelizing the productive phase and the regeneration phase between multiple without using multiple liquid chromatography machines. By continuously generating the gradient and analyzing samples with a detector in parallel, disclosed embodiments result in a significant reduction in overall cost from reduced machine downtime, reduced laboratory overhead costs, and reduced spending on laboratory equipment.

For example, in at least one implementation, the present invention can include a high-duty-cycle liquid chromatography system that comprises two or more columns that are configured to alternatingly be in a productive phase or a regeneration phase. In particular, one of the two or more columns is in a productive phase while another one or more of the two or more columns is in the regeneration phase. Additionally, the system can include a single mobile phase gradient delivery pump, and a single isocratic pump. In some aspects, the system can also include two or more gradient storage chambers and two or more valves.

The valves of the system can be each independently coupled to one of the columns and one of the gradient storage chambers. Each valve can in turn be configured to alternately connect one of the gradient storage chambers to one of the columns while simultaneously enabling storage of solvent via the other gradient storage chambers. As such, one column is in the productive phase when the coupled valve connects to one of the two or more gradient storage chambers to the column, and the column is configured to deliver analyte to a detector. Meanwhile, the column is in the regeneration phase when the single mobile phase gradient delivery pump is configured to selectively provide a mobile phase gradient and a sample to the gradient storage chambers undergoing regeneration. The mobile phase gradient can include mobile phase A solvent and mobile phase B solvent. The isocratic pump can be configured to push a mobile phase A solvent through each of the columns at the same time.

In an additional or alternative implementation, the present invention can comprise a method of using a high-duty-cycle liquid chromatography system. In this case, the method includes obtaining a sample, and moving a valve to couple a mobile phase gradient delivery pump and a gradient storage chamber. The mobile phase gradient delivery pump is used to pump a mobile phase gradient and the sample to the gradient storage chamber via the valve. An isocratic pump is used to pump a mobile phase A through a column to a waste area. Once the mobile phase gradient and the sample are entirely pumped into the mobile phase gradient storage chamber, the valve is moved to couple the column with the gradient storage chamber. Thus, the method further includes applying a voltage to the column to couple the column to a detector. The mobile phase gradient and the sample are pushed through the column by pumping, by the isocratic pump, the mobile phase A through the column to the detector. Lastly, the method includes analyzing the sample by the detector.

In some aspects, the techniques described herein relate to a high-duty-cycle liquid chromatography computing system having a processor, a memory, and a storage having stored thereon computer-executable instructions that are structured such that, when the computer-executable instructions are executed by the processor. The high-duty-cycle liquid chromatography computing system identifies a column to undergo a regeneration phase and moves a valve to couple a gradient storage chamber with a mobile phase gradient delivery pump. The system then identifies the gradient storage chamber contains a sample solution and moves the valve to couple the gradient storage chamber with the column. The system identifies when the sample solution has moved from the gradient storage chamber to the column.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 illustrates a overview schematic of a liquid chromatography system employing multiple columns;

FIG. 2 illustrates an example schematic of using the liquid chromatography system;

FIG. 3A illustrates an example schematic of a valve connected to a column in the regeneration phase;

FIG. 3B illustrate an example schematic of the value of FIG. 3A after it has been rotated, and the column is switched to the productive phase;

FIG. 4A illustrates a valve connected to a column in the productive phase;

FIG. 4B illustrates the valve of FIG. 4A now in the regeneration phase;

FIG. 5 illustrates an example of an expanded column;

FIG. 6A illustrates an example schematic of the liquid chromatography system with three columns where the three columns alternate between a regeneration phase and a productive phase;

FIG. 6B illustrates the example schematic of FIG. 6A, in which the valves are rotated to change which column(s) are being regenerated versus which are being used for production;

FIG. 6C illustrates a further example schematic in which the valves of FIG. 6B are rotated to again active the columns for regeneration versus production;

FIG. 7 illustrates a flowchart of a series of acts in a method of using the liquid chromatography system to separate an analyte;

FIG. 8 illustrates a flowchart of a series of acts in a method of controlling valves to alternate between production and regeneration cycles;

FIG. 9 illustrates experimental results of columns being alternatively regenerated; and

FIG. 10 illustrates experimental results comparing a HeLa digest one-hour gradient chromograms.

### DETAILED DESCRIPTION

Embodiments described herein relate to systems and methods for performing high-duty-cycle liquid chromatography using low flow rates (or high flow rates, if desired) for high sensitivity. In one example, the high-duty-cycle liquid chromatography system is configured to increase the portion of time during which the detector actively analyzes samples while still maintaining a low flow rate and implementing a short analysis time per sample by parallelizing the productive phase and the overhead phases between multiple liquid chromatography columns without using multiple liquid chromatography machines. By continuously generating the gradient and analyzing samples with a detector, disclosed embodiments result in a significant reduction in overall cost from reduced machine downtime, reduced laboratory overhead costs, and reduced spending on laboratory equipment.

Disclosed embodiments provide many advantages. For example, liquid chromatography gradient generation can be performed at much greater speeds. That is, gradients may be produced over a timer interval that is up to 10 times faster than the gradients are being used in the analysis. Additionally, liquid chromatography gradient generation can be performed at lower pressure because the analytical column is not directly connected to the gradient pump. Due to the higher gradient generation speeds, a single mobile phase delivery pump can support multiple analytical columns. The accelerated gradient generation takes place at a proportionately higher flow rate, bringing the gradient pump into a flow regime where it can operate without requiring a solvent-waste splitter.

Disclosed embodiments may also provide constant high-pressure elution which eliminates any interdependence of flow rate between parallel channels as the viscosity of the mobile phase changes during peptide elution and column washing and regeneration. In another example, isolation of the low pressure (e.g., gradient generation and sample introduction) flow path from the high-pressure elution path reduces the number of high-pressure fittings and increases system robustness. The disclosed storage loop design enables partial collection from the optional sample introduction solid phase extraction (SPE) column such that unwanted particles (e.g., salts and lipids) are never introduced to the analytical column, resulting in an increased overall system robustness. Additionally, the use and backflushing of the SPE column reduces the retention volume from the sample introduction which leads to the sample refocusing on the analytical column without a gradient dilution. Disclosed embodiments also perform constant pressure isocratic elution, which enables ultra-low flow rate elution without requiring high-pressure ultra-low flow gradient generation pumps.

Disclosed embodiments also will be understood to provide significant cost benefits. By continuously performing, in parallel, liquid chromatography gradient generation and analyzing samples with a detector, disclosed embodiments lower (or may even eliminate) the amount of down time of the detector which results in a significant reduction in overall cost. Additionally, disclosed embodiments increase productivity of the machines without introducing additional laboratory equipment therefore saving precious laboratory space, and saving overall laboratory overhead costs.

Disclosed embodiments include a system and method wherein one or more liquid chromatography columns are operated with a single liquid chromatograph (including pumps, autosampler, etc.) and a single detector (e.g., a mass spectrometer) to significantly improve sample throughput without sacrificing separation performance (e.g., peak capacity). In embodiments described herein, a multicolumn liquid chromatograph may be operated using accelerated gradient generation followed by gradient/sample storage and constant-pressure isocratic elution as a straightforward means of achieving liquid chromatography, while also achieving mass spectrometry duty cycles approaching 100% even at low (or ultra-low) flow rates.

Based on the disclosure of rapidly generating gradients and eluting all the liquid chromatography columns using a single high-pressure pump, at least one disclosed embodiment utilizes a system with at least two channels. In one example, the multicolumn nano-liquid chromatography setup includes a single binary pump operating at low pressure which elutes peptides from a sample-containing solid-phase extraction column into one of the multiple storage loops. Concurrently, a high-pressure isocratic pump drives mobile phase A both through the analytical column connected to the same valve as this storage loop for regeneration as well as pushing a previously stored sample and mobile phase gradient through the other analytical column for liquid chromatography mass spectrometry analysis. In this example, by generating the gradient and loading the sample into one of several storage loops faster than elution takes place, the high-pressure pump can continuously separate peptides on the multiple analytical columns.

In further examples, three valves (or more) can be used in a two- (or more) channel system. For example, one of the valves may comprise a 10-port valve, which performs sample introduction. Another valve may comprise a 6-port valve for each analytical column to switch the storage loop between gradient generation path and high-pressure separation path. Additional columns add an additional one valve each, which can be rotated or activated by other means to switch various ports therein on or off, as further discussed below.

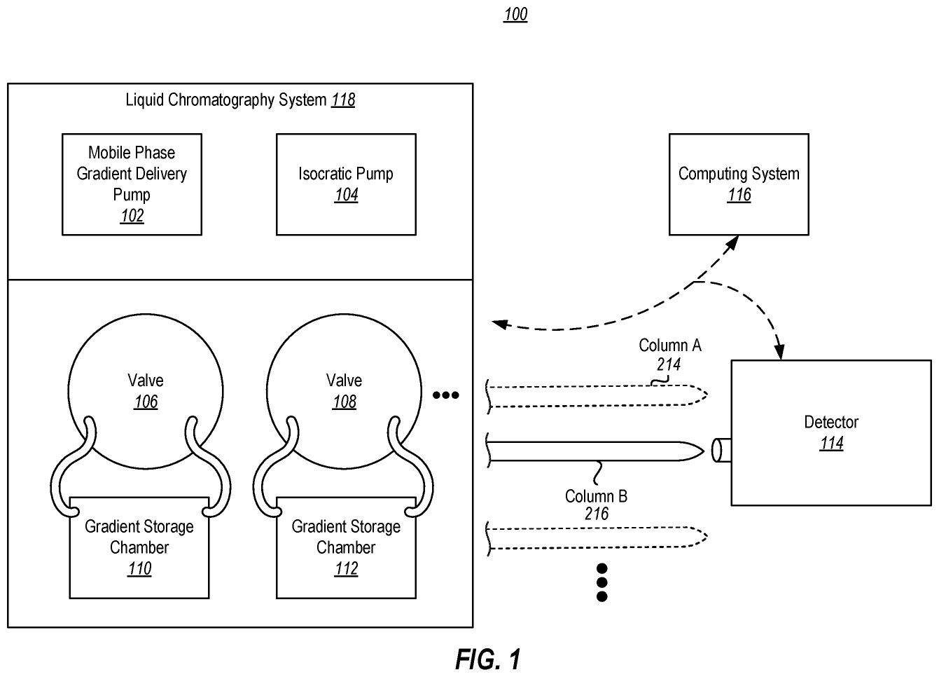

Turning now to the Figures, FIG. 1 illustrates an overview example schematic showing a high-duty-cycle liquid chromatography system 100, which in turn includes a liquid chromatography device 118, which further includes a mobile phase gradient delivery pump 102, an isocratic pump 104, two rotatable valves (106 and 108), two gradient storage chambers 110 and 112, and two columns (214 and 216). The system 100 also can include a detector 114, and a computing system 116 which are coupled to the liquid chromatography system 118. The computing system can be used to control (among other things) valves 106 and 108. In some embodiments the liquid chromatography system 100 is configured to provide a duty cycle of about 80%, about 90%, about 95%, or greater than 95%.

In general, the liquid chromatography system is configured to receive a sample. The sample is obtained by a sample valve (described in more detail below) which is connected to the mobile phase gradient delivery pump 102. The mobile phase gradient delivery pump 102 pumps the sample and the gradient mobile phase to the gradient storage chamber 110 via valve 106 which is coupled to column A 214. As shown, the isocratic pump 104 pumps a solvent to column A 214 via the valve 106 and column A 214 is in a regeneration phase. As a preliminary matter, and by way of explanation, columns or related tubing shown in solid lines just before detector 114 can be understood as being “active” columns that are currently delivering analyte to detector 114. Meanwhile, columns or related tubing shown in dotted lines may be understood as “inactive,” meaning that they are undergoing regeneration (instead of production) in various stages, and not delivering analyte to the detector 114.

Returning to the Figures, FIG. 1 also shows a second valve 108 with corresponding gradient storage chamber 112 where the gradient storage chamber 112 already contains the gradient mobile phase and the sample. As shown, the isocratic pump 104 also pumps solvent to column B 216 via valve 108 which pushes the gradient mobile phase and sample through the column B 216 where column B 216 is in a productive phase. The column B 216 is coupled to the detector 114 (i.e., is activated for production) to thereby delivery analyte to detector 114, which then analyzes the separated sample/analyte received from column B 216.

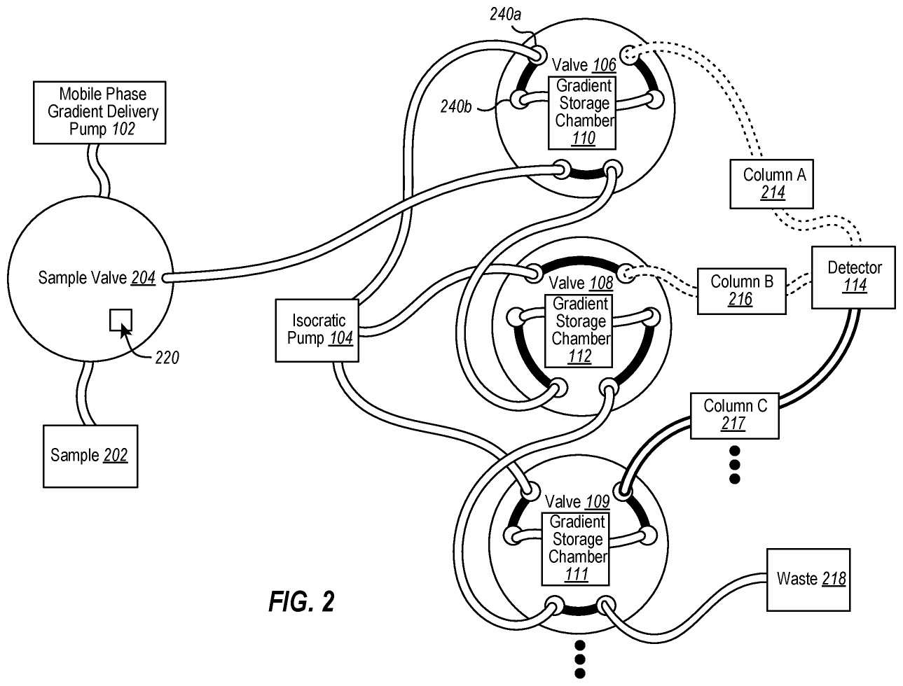

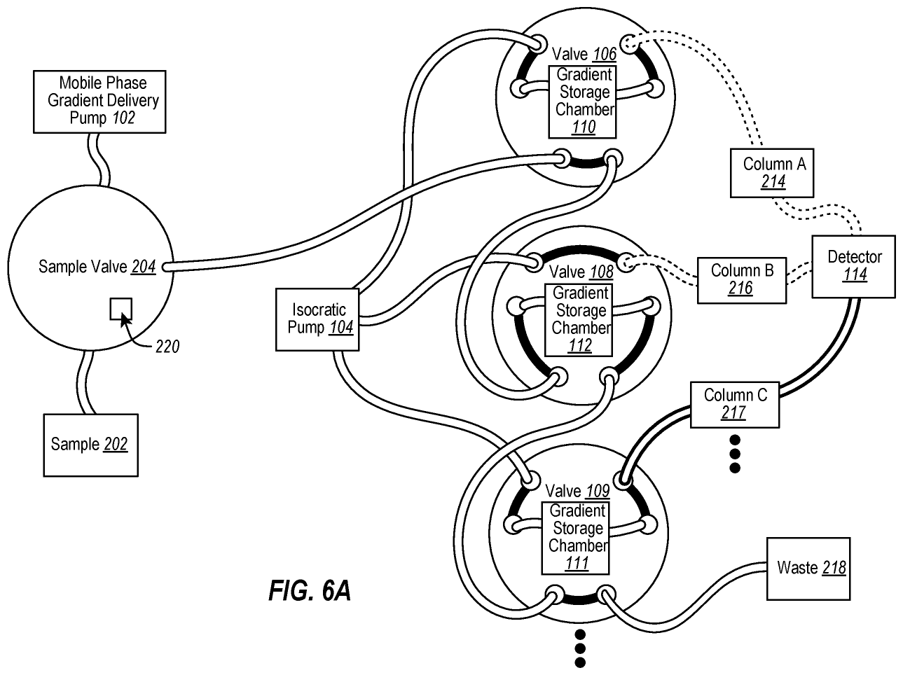

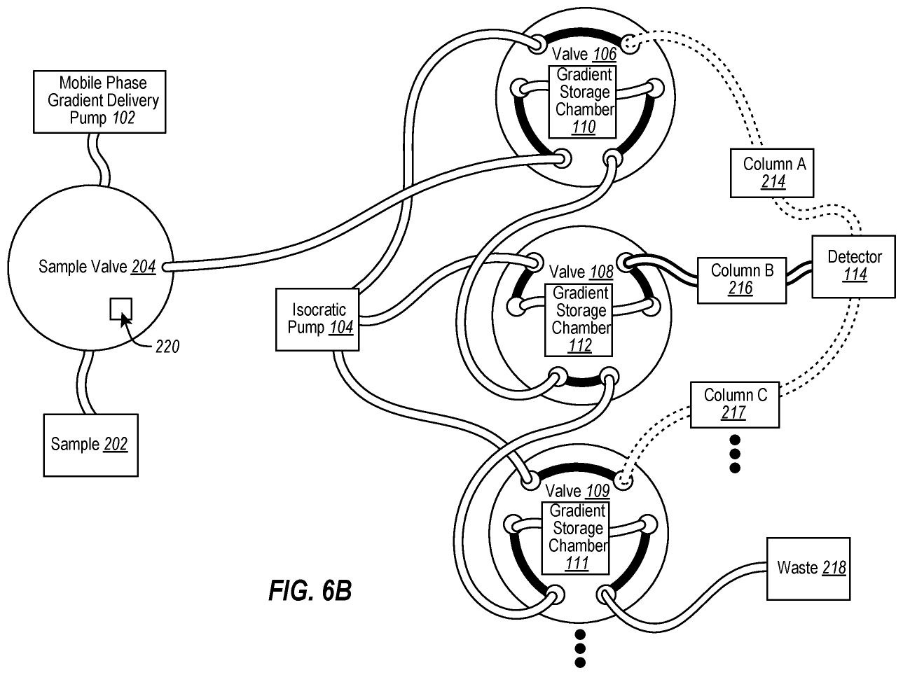

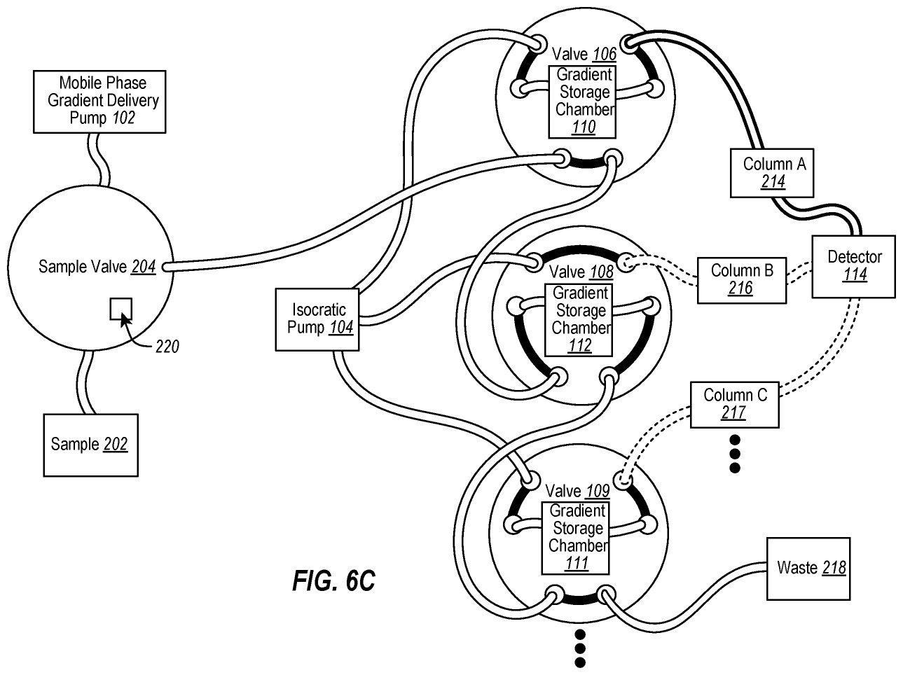

As previously noted, it will be appreciated that the liquid chromatography system 100 may include more than two valves and more than two gradient storage chambers as shown and described in FIG. 2 and FIGS. 6A-6C below. In some embodiments, the number of valves is equal to the number of gradient storage chambers. Alternatively, the number of valves may be greater than the number of gradient storage chambers (e.g., a valve corresponding to each gradient storage chamber and a sample valve).

In the liquid chromatography system 100, the mobile phase gradient delivery pump 102 (also known as a gradient pump) and the isocratic pump 104 are independently connected to each valve 106 and 108. In some embodiments, the mobile phase gradient delivery pump 102 may be a binary pump. In some embodiments, mobile phase gradient delivery pump 102 is configured to pump a mobile phase gradient (solution) and a sample to the gradient storage chambers 110 and 112 via the corresponding valves 106 and 108, respectively. The mobile phase gradient may include a mobile phase A solution, and a mobile phase B solution. In some embodiments, the mobile phase A solution may comprise an aqueous solvent and the mobile phase B solution may comprise an organic solvent. In some embodiments, the mobile phase delivery pump increases the solvent strength of the mobile phase gradient by gradually increasing the composition of solvent from mobile phase A to mobile phase B. In yet another embodiment, the mobile phase delivery pump is configured to produce a gradient of increasing solvent strength from three or more solvents.

The gradient storage chambers 110 and 112 of FIG. 1 may comprise storage loops (not shown). In the alternative, the gradient storage chambers may have other configurations (e.g., linear, non-looping) may be applicable. In one embodiment, storage loops comprise coiled tubes in the form of capillary having a length of approximately 570 cm, an internal width of approximately 30 μm diameter, and an internal volume of approximately 4.0 μL.

The liquid chromatography device 118 may further include a trapping column (element 220, FIG. 2). The trapping column may be positioned in the flow path between the mobile phase gradient delivery pump 102 and the two gradient storage chambers 110 and 112.

In general, isocratic pump 104 may be configured to pump a mobile phase A solvent through each valve simultaneously. Alternatively, the isocratic pump 104 may be configured to pump mobile solvent A through only one valve at a time. In other embodiments, the isocratic pump 104 may pump solvent A through each valve individually where there may comprise a time that the isocratic pump 104 is pumping through only one valve at a specified time and another time where the isocratic pump 104 is pumping through all the valves at the same time. In an example, the isocratic pump includes a tee with one side being connected to a constant high pressure elution pump with mobile phase A, which flows at a pressure of 400-1,000 bar. On the other side of a tee (not shown) may comprise a high flow split (not shown) which maintains constant pressure. The isocratic pump 104 may be configured to operate at a constant pressure or a constant flow rate.

With further reference to FIG. 1, the detector 114 may comprise a mass spectrometer (one or a plurality, in some scales), or other applicable instrument for measuring analytes from an LC column. For example, in other embodiments, the detector 114 may comprise an optical detector. However configured, the detector 114 is arranged to identify species with analytes delivered from a given column. For example, in one example, the detector 114 13 is configured to identify from a separated sample 1,000 unique species, at least 1,000 unique species, 3,000 unique species, 5,000 unique species, or more than 5,000 unique species. In some embodiments the unique species may include proteins, fragments, lipids, metabolites, or a combination thereof. The detector 114 used in accordance with the present system 100 may analyze samples at a rate of 1 sample per hour, more than 1 sample per hour, 5 samples per hour, 10 samples per hour, or more than 10 samples per hour.

As previously disclosed, system 100 can further include a computing system 116. The computing system 116 may be used in the analysis of the separated analyte sample received from the detector 114, and may be further used to operate valves 106, 108, etc. That is, the computing system 116 may be used to operate the liquid chromatography device 118, such as to rotate each valve to in turn, connect different ports within the valves, and change the direction of flow. For example, in the illustrated embodiments, the computing system 116 may operate the valves 106 and 108 to switch the given ports therein, thereby changing columns between connection to the corresponding gradient storage chambers, and thereby switch the columns to be in a regeneration phase, or alternatively in a productive phase. Along these lines, the computing system 116 can be further configured to control the mobile phase gradient delivery pump 102 and the isocratic pump 104, and thus control the distribution of mobile phase A versus mobile phase B, as applicable.

In some embodiments, the computing system 116 may further operate or otherwise be communicably coupled with the detector 114 to receive signals representing results of analysis. Furthermore, the liquid chromatography 118 may operate other devices or hardware found in the overall liquid chromatography system 100.

FIG. 2 illustrates a more detailed schematic of the overall process from obtaining the sample 202 to separating the sample by a column 217, which is connected to a detector 114. In some embodiments, the sample 202 may be a biological sample. In these embodiments, the sample 202 may include tissues, biopsies, cell homogenates, cell fractions, cultured cells, non-cultured cells, whole blood, plasma, biological fluids, single cells, or a combination thereof. The sample 202 can be loaded by an autosampler to a sample valve 204. Additionally or alternatively, the sample 202 is loaded by hand to the sample valve 204. In yet other embodiments, the sample 202 may be loaded into the sample valve 204 by other appropriate means such as an autosampler.

In some embodiments, the sample valve 204 may include a solid phase extraction column, or SPE column. The sample valve can include a waste port, a loading pump, a 10 μL sample loop, a sampling needle, and an autosampler syringe pump and is connected to the gradient pump.

The sample valve 204 may further include a trapping column 220. The trapping column may be positioned in the flow path between the mobile phase gradient delivery pump 102 and the gradient storage chambers 110, 112, and 111 within the sample valve 204. The trapping column 220 optionally collects the sample 202 prior to be sent to the gradient storage chamber 110 via the valve 106 by the mobile phase gradient delivery pump 102.

Once the sample is loaded into the sample valve 204, the present system can use the mobile phase gradient delivery pump 102 (which may comprise a set of one or multiple pumps, such as a binary, ternary, etc. set of pumps) to pump a gradient solvent and the sample to the gradient storage chamber 112 via the valves 106 and 108. Meanwhile, the gradient storage chamber 112 is being filled with the gradient solvent and sample mixture by the mobile phase gradient delivery pump 102, and the leftover waste found in the gradient storage chamber 112 is pumped to valve 109 and to waste 218. By pushing leftover waste found in the gradient storage chamber 112 to the waste collector 218, insoluble debris or unwanted chemical species are avoided being delivered to the columns while the columns are in the productive phase and deliver analyte to the detector 114.

Turning now to valve 106, the isocratic pump 104 is coupled to valve 106 through a particular port (e.g., port 240a) of valve 106, and this port is further coupled to the gradient storage chamber 110 through another port (e.g., port 240b) of valve 106. In general, the isocratic pump 104 pumps solvent A through the gradient storage chamber 110 and column A 214 as well as column B 216, where both column A 214 and column B 216 are undergoing the regeneration process.

Turning now to the valve 109, the gradient storage chamber 111 (which already contained a sample) is coupled to a column C 217 due to the rotated orientation of the valve 109. Because of its orientation, the relevant ports are activated such that column C 217 is currently in a productive phase (e.g., pushing analyte to the detector 114). The isocratic pump 104 pushes mobile phase A solvent through the gradient storage chamber 111 which contains the mobile phase gradient and the sample which results in the sample being pushed through the productive phase column C 217. As shown, the productive column C 217 is coupled to the detector 114. As an example, the column C 217 may be coupled to the detector 114 by applying a voltage. Alternatively, the column C 217 may be coupled to the detector 114 manually, by a switch, by computer executable instructions from the computing system 116, or by other appropriate means.

In general, the mobile phase (A/B) passes through the columns 214, 216, and 217 at a flow rate of less than 25 nL/min, about 25 nL/min, about 50 nL/min, about 100 nL/min, about 200 nL/min, about 300 nL/min, or above 300 nL/min. In some embodiments, the mobile phase gradient delivery pump 102 operates at a flow rate greater than the flow rate of the mobile phase passing through the columns 214, 216, and 217. In some embodiments, the mobile phase gradient delivery pump 102 operates at the same flow rate as the mobile phase passing through the columns 214, 216, and 217. In some embodiments, the gradient storage chambers 110 and 112 comprise a narrow length of tubing which have an internal diameter that is smaller than the tubing length (e.g., less than 100× smaller, about 100× smaller, about 150× smaller, about 200× smaller, greater than 200× smaller).

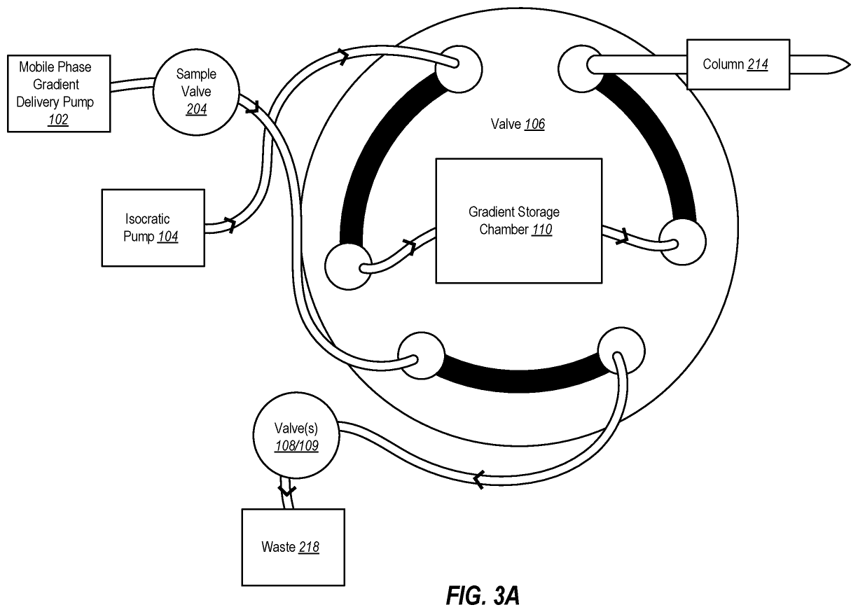

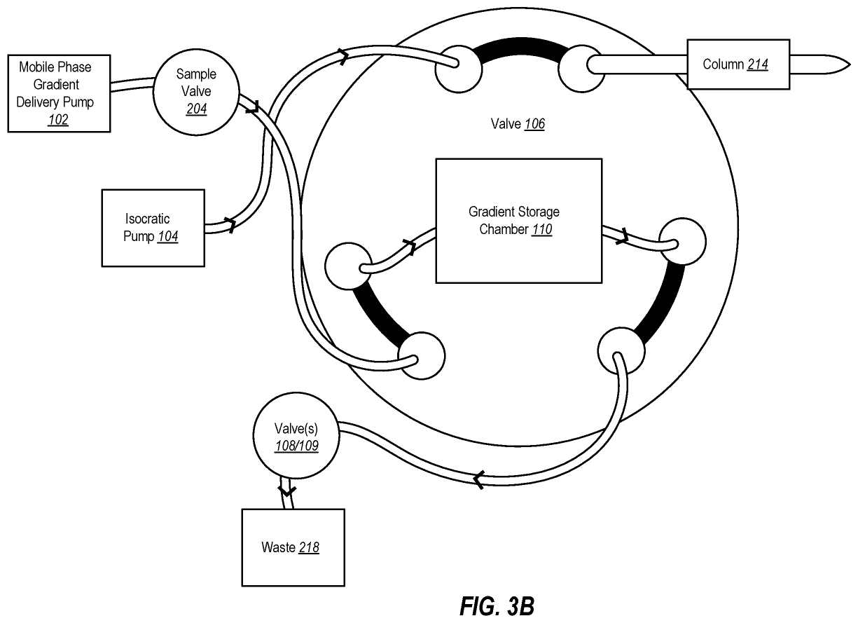

FIGS. 3A and 3B illustrate examples of one valve (106) in the productive phase and the regeneration phase, respectively. In particular, FIG. 3A illustrates an example valve 106 with the column A 214 in the productive phase. In this example, the gradient storage chamber 110 has previously been filled with the mobile phase gradient and the sample. Any waste from the system may be removed to a waste receptacle 218 via valves 108 and 109, as previously shown in FIG. 2. In general, the isocratic pump 104 pushes mobile phase A solvent through the gradient storage chamber 110, which results in the sample being pushed through the column A 214 and to the detector 114.

FIG. 3B illustrates the example valve 106 with a column A 214 in the regeneration phase. In this example, the gradient storage chamber 110 is being filled with the mobile phase gradient along with the sample by the mobile phase gradient delivery pump 102. Any fluid that was already in the gradient storage chamber 110 is also being pushed from the gradient storage chamber 110 to waste 218 via connection with valves 108 and 109 (FIG. 2). In this example, the isocratic pump 104 is pumping mobile phase A solvent through the column A 214 to regenerate the column.

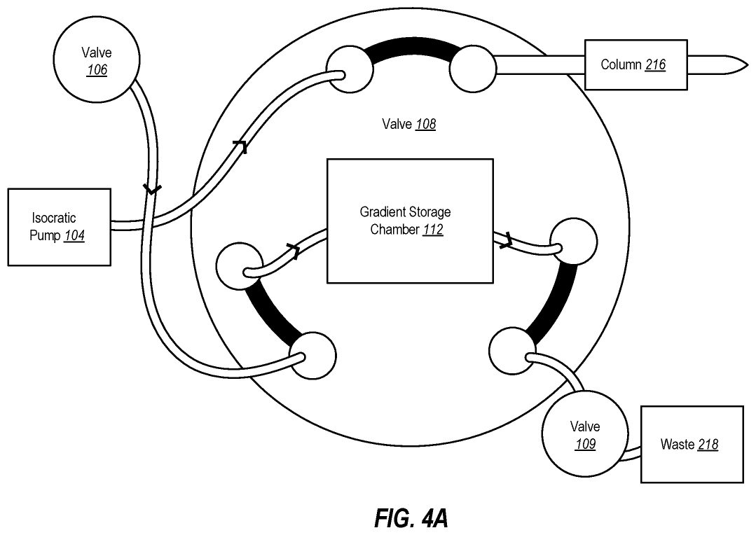

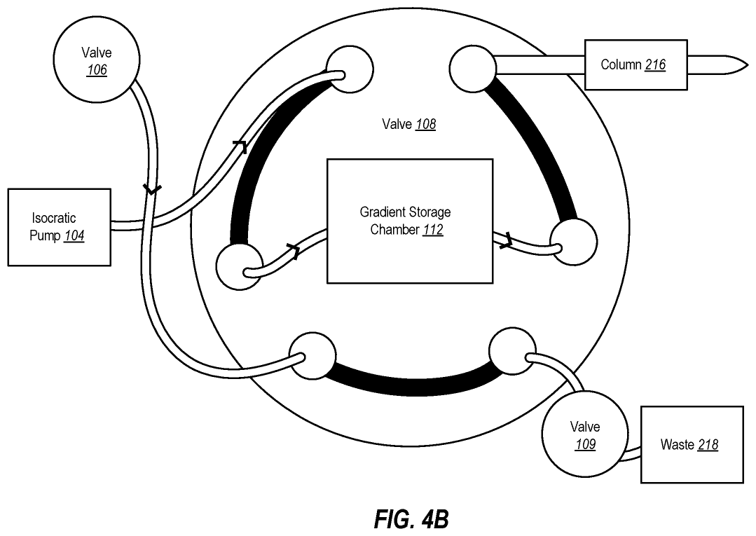

FIGS. 4A and 4B illustrate examples of one valve (108) in the regeneration phase and the productive phase, respectively. FIG. 4A illustrates an example valve 108, which is rotated such that the relevant ports therein are activated so that column B 216 in the regeneration phase. In this example, the gradient storage chamber 112 is being filled with the mobile phase gradient along with the sample by the mobile phase gradient delivery pump 102. Any fluid that was already in the gradient storage chamber 112 is also being pushed from the gradient storage chamber 112 to waste 218 via valve 109, as shown in FIG. 2. In this example, the isocratic pump 104 is pumping mobile phase A solvent through the column B 216 to regenerate the column.

FIG. 4B illustrates an example valve 108 now rotated differently from FIG. 4A, such that the relevant ports are activated so that column B 216 in the productive phase. In this example, the gradient storage chamber 112 has previously been filled with the mobile phase gradient and the sample. Any waste from the system, including waste from other valves 106, may be removed to a waste receptacle 218 via valve 109. In general, the isocratic pump 104 pushes mobile phase A solvent through the gradient storage chamber 112, which results in the sample being pushed through the column B 216 and to the detector 114.

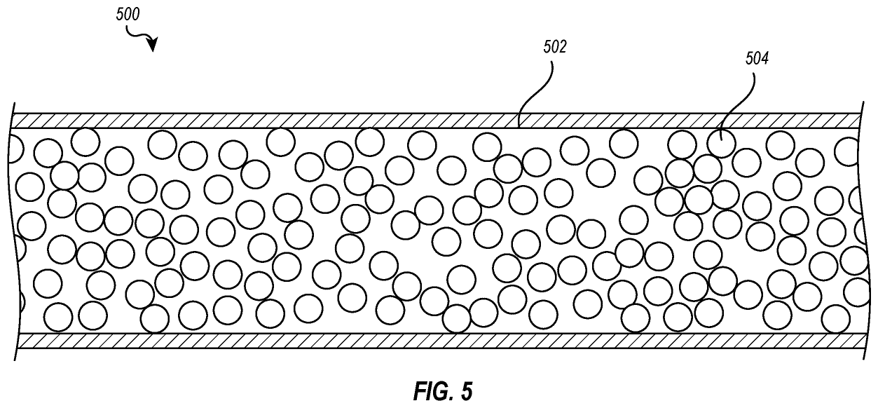

FIG. 5 illustrates a close-up schematic example of a column, namely column 500. The exemplary column 500 includes an outside tubing 502 and inside spheres 504. The spheres 504 may attract components from the sample to elute the species at different speeds. The spheres 504 may be formed of silica coated with hydrocarbons other appropriate materials.

FIGS. 6A through 6C illustrate examples of an optional three column system where each column switches between a regeneration and productive phase in a similar fashion as FIGS. 3A-3B and 4A-4B. Depending on the analyzer instrument, in one implementation, one column may be in a production phase, while the other two (or more, however configured) may be in the regeneration phase.

Turning now to the Figures, FIG. 6A shows column A 214 and column B 216 in a regeneration phase and column C 217 in a productive phase. Similarly to FIG. 2, sample 202 is obtained by the sample valve and may optionally be collected in the trapping column 220. The mobile phase gradient delivery pump 102 pushes the sample and mobile phase gradient to valve 106. The gradient mobile phase and sample 202 are then further pushed to valve 108 where the sample and mobile phase gradient are collected in gradient storage chamber 112. Any prior mobile phase in the gradient storage chamber 112 is sent to waste 218 via valve 109.

Meanwhile, the isocratic pump 104 pumps solvent to each valve (106, 108, and 109). Referring to valve 106, the isocratic pump 104 pushes solvent through the gradient storage chamber 110 and then through the column A 214 since the given orientation of valve 106 is such that its given ports are activated to place column A in a regeneration phase. Referring to valve 108, because of its current orientation, the isocratic pump 104 pushes solvent straight to column B 216 which is also undergoing regeneration. Referring to valve 109, valve 109 is oriented such that the isocratic pump 104 pushes the sample (which was previously stored in the gradient storage chamber 111) into the column C 217, which is coupled to a detector 114. In this example, column C 217 is shown in a productive phase.

Once all the sample is separated and received by the detector 114 from the productive phase column C 217, and columns A and B (214 and 216) are regenerated, the valves (106, 108, and 109) are moved to a new configuration/orientation shown in FIG. 6B, which alters the connection of various ports within each valve, as discussed herein. As shown in FIG. 6B, column A 214 and column C 217 are now in the regeneration phase, while at the same time column B 216 is now in the productive phase. That is, the ports of valves 106 and 109 are switched now so the given valves 106 and 109 place corresponding columns 214 and 217 in a regeneration phase.

In more detail, a new sample 202 is now obtained by the sample valve 204 and may optionally be collected in the trapping column 220. The mobile phase gradient delivery pump 102 pushes the sample and mobile phase gradient to valve 106 and collects the sample 202 and mobile phase gradient in the gradient storage chamber 110. Any prior mobile phase in the gradient storage chamber 110 is sent to valve 108 and then to valve 109 and through the gradient storage chamber 111. The waste from the gradient storage chamber 110 and 111 are then sent to waste 218.

Meanwhile, the isocratic pump 104 pumps solvent to each valve (106, 108, and 109). Referring to valve 106, the isocratic pump 104 pushes solvent through the column A 214 which is in a regeneration phase. Referring to valve 108, the isocratic pump 104 pushes solvent through the gradient storage chamber 112, which contains a sample and gradient mobile phase, and then through column B 216 and to a detector 114 (e.g., column B 216 is in a productive phase). Referring to valve 109, the isocratic pump 104 pushes solvent through the column C 217 which is in a regeneration phase.

Similarly, once all the sample is separated and received by the detector 114 from the productive phase column B 216 and columns A and C (214 and 217) are regenerated, the valves (106, 108, and 109) are moved to a new configuration shown in FIG. 6C. As shown in FIG. 6C, column B 216 and column C 217 are now in the regeneration phase and column A 214 is now in the productive phase.

In more detail, a new sample 202 is now obtained by the sample valve 204 and may optionally be collected in the trapping column 220. The mobile phase gradient delivery pump 102 pushes the sample and mobile phase gradient to valve 106 and further to valve 108 where the gradient storage chamber 112 collects the sample 202 and mobile phase gradient. Any prior mobile phase in the gradient storage chamber 112 is sent to valve 109 and sent to waste 218.

Meanwhile, the isocratic pump 104 pumps solvent to each valve (106, 108, and 109). Referring to valve 106, the isocratic pump 104 pushes solvent through the gradient storage chamber 110 that contains the sample and gradient mobile phase and further through column A 214 which is in a productive phase. As shown, column A 214 is coupled to the detector 114 and the separated sample is sent to the detector 114 to be analyzed. Referring to valve 108, the isocratic pump 104 pushes solvent through column B 216 where column B 216 is in a regeneration phase. Referring to valve 109, the isocratic pump 104 pushes solvent through the column C 217 which is in a regeneration phase.

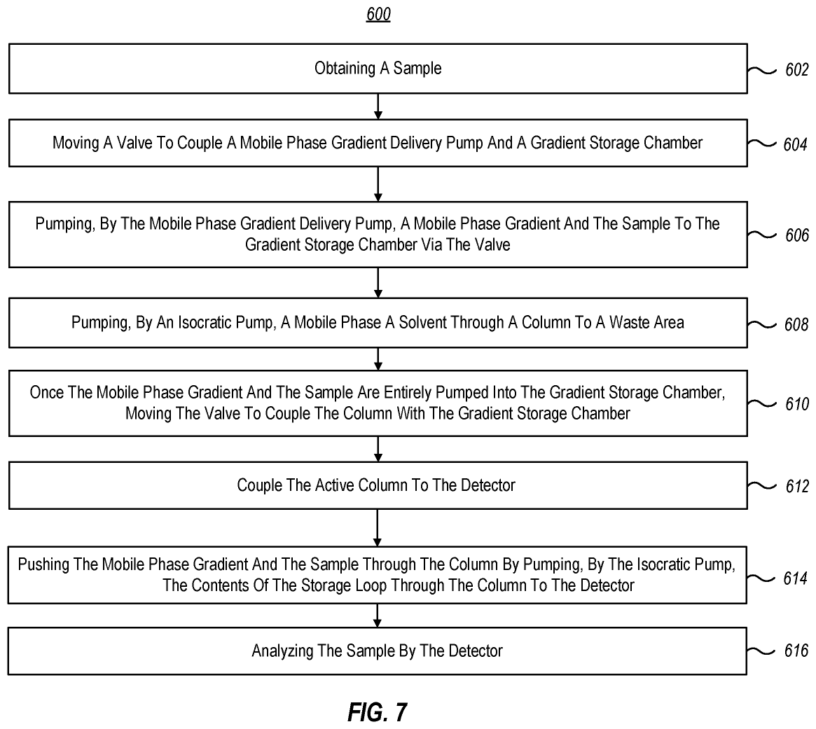

FIG. 7 illustrates a flowchart of an exemplary method for using the liquid chromatography system 100 to separate and analyze a sample in one column while regenerating another column at the same time. For example, FIG. 7 shows that method 600 includes obtaining a sample (act 602). In some embodiments, the sample may be a biological sample, an organic sample, an inorganic sample, or other sample of interest to be separated using liquid chromatography techniques. FIG. 7 also shows that method 600 includes moving a valve (e.g., 106) to couple a mobile phase gradient delivery pump (e.g., 102) to a gradient storage chamber (e.g., 110) (act 604). In some embodiments, the valve is moved by instructions from a computing system (e.g., 116).

In addition, FIG. 7 shows that method 600 further includes pumping, by the mobile phase gradient delivery pump, a mobile phase gradient and the sample to the gradient storage chamber via the valve (act 606). In some embodiments, the mobile phase gradient is made up of a mobile phase A solvent and a mobile phase B solvent. In these embodiments, the mobile phase A solvent may be an aqueous solvent and the mobile phase B solvent may be an organic solvent. The method 600 also includes pumping, by an isocratic pump (e.g., 104), a liquid such as mobile phase A solvent through a column (e.g., 214) to a waste area (e.g., 218) (act 608).

Additionally, FIG. 7 shows that method 600 includes an act of: once the mobile phase gradient and the sample are entirely pumped into the gradient storage chamber, moving the valve to couple the column with the gradient storage chamber (act 610). Similarly to above, the valve may be moved by computer executable instructions from the computing system (e.g., 116). Furthermore, FIG. 7 shows that method 600 can include applying a voltage to the column configured to couple the column (e.g., 216) to a detector (e.g., 114) (act 612). The applied voltage may be controlled by the computing system (e.g., 116) and allows the detector (e.g., 114) to receive and analyze the separated sample from the column (e.g., 216). Alternatively, the productive column may be coupled to the detector by, e.g., positioning the productive column in front of the detector or by means of an additional valve.

Still further, FIG. 7 shows that method 600 can include pushing the mobile phase gradient and the sample through the column by pumping, by the isocratic pump, the mobile phase A solvent through the column to the detector (act 618) and analyzing the sample by the detector (act 620). In some embodiments the detector may be a mass spectrometer. In other embodiments, the detector may be an optical detector. In at least one implementation, analyzing the sample may identify at least 1,000 unique species, at least 3,000 unique species, at least 5,000 unique species, or more than 5,000 unique species. The results of the analysis may be sent to the computing system (e.g., 116) for further analysis. In other embodiments, the results may be rendered as a visual representation of the computing system.

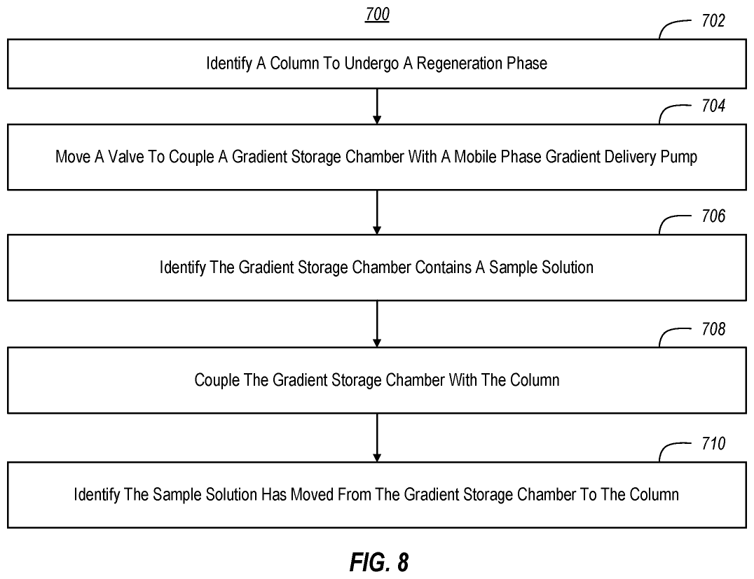

FIG. 8 illustrates an additional exemplary method for using the computing system (e.g., 116) to operate the valves (106, 108) of the liquid chromatography system 100. For example, FIG. 8 shows that method 700 includes identifying a column to undergo a regeneration phase (act 702). The column in the regeneration phase is illustrated in FIG. 3A. In addition, FIG. 8 shows that method 700 can include moving a valve (e.g., 106) to couple a gradient storage chamber with a mobile phase gradient delivery pump (e.g., 102) (act 704). For example, the valve may be moved by one or more switches operated by computing system 116. Furthermore, FIG. 8 shows that method 700 can include identifying that the gradient storage chamber contains a sample solution (act 706).

Furthermore, FIG. 8 shows that method 700 can include moving the valve to couple the gradient storage chamber with the column (act 708). At this point, the column is now in the productive phase. Still further, FIG. 8 shows that method 700 can include identifying the sample solution has moved from the gradient storage chamber to the column (act 710). At this point, the valve may move the column back into a regeneration phase.

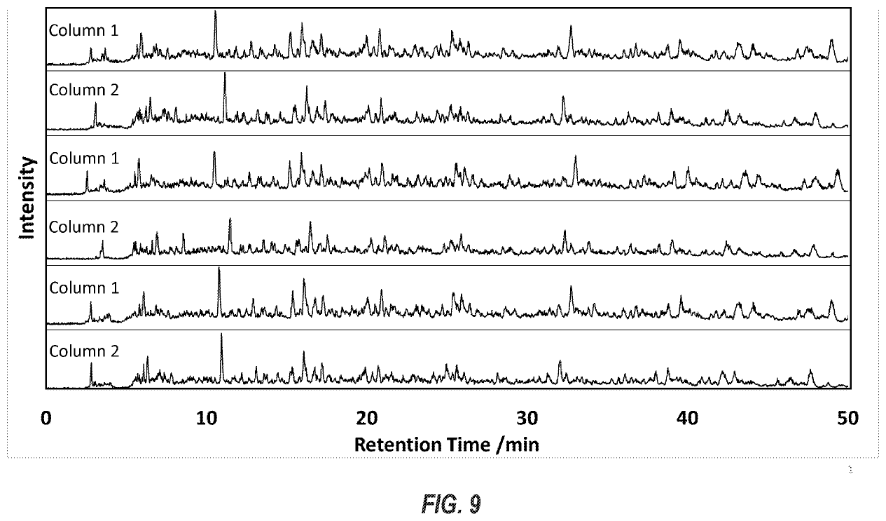

FIG. 9 illustrates experimental results comparing the results of two columns alternating between the productive and regeneration phase. As shown in FIG. 9, the intensity peaks of column 1 and column 2 align indicating no loss in performance when alternating the columns between regeneration and production.

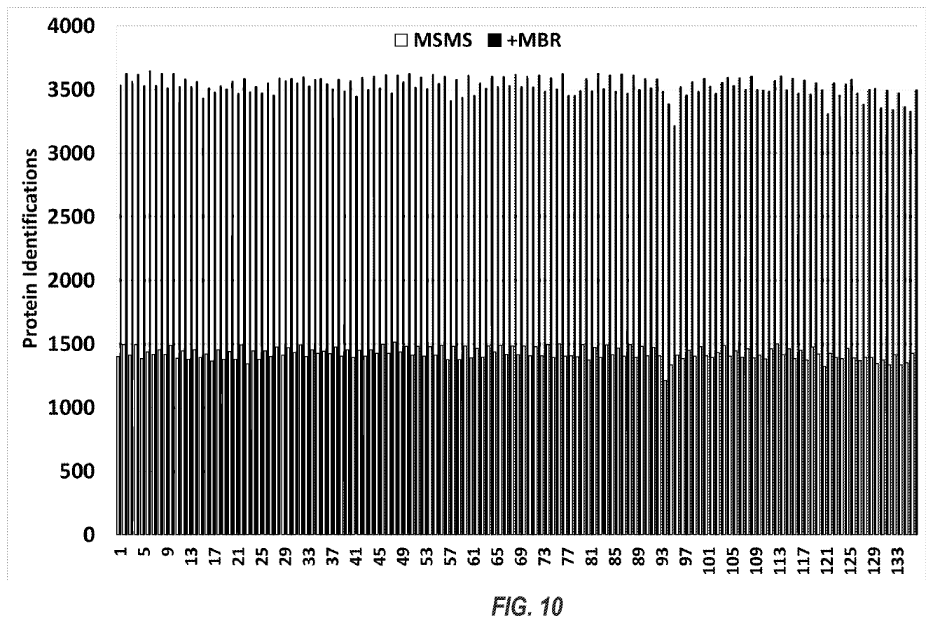

FIG. 10 illustrates experimental results of the number of proteins identified in two columns. As shown, a similar number of proteins are identified by the columns. These results indicate the alternating regeneration and production columns are effective in separating analytes and identifying proteins.

Additional experiments were conducted to compare a conventional constant low-flow liquid chromatography setup with the disclosed embodiments liquid chromatography setup. The binary pump of the conventional constant flow liquid chromatography separations operated at about 37 nL/min, however, in the experiment involving storage of the sample and gradient in a gradient storage chamber, the initial flow rate was set four times higher at 150 nL/min to enable the possibility of four parallel channels. To simplify the experiment, only one channel was utilized for the comparison.

First, 1.0 μL of 2 ng/μL HeLa protein digest was loaded onto the 50 μm internal diameter (i.d.) by 5 cm long SPE column and eluted with a 15 minute gradient at a flow rate of 150 nL/min. This resulted in roughly 3.9 μL of eluent (including the sample, gradient, and column wash) that was pushed and stored inside a 570 cm long, 30 μm i.d. empty capillary, where the total capillary volume was about 4.0 μL.

In the following step, the 6-port valve witches the storage loop from the low-pressure gradient generation path to the high-pressure elution path. In the high-pressure elution path, a high-pressure pump pushes mobile phase A at 1.1 μL/min through a 350 cm long by 15 μm i.d. capillary to create a constant-pressure of about 410 bar at the tee. A 30 cm long by 30 μm i.d. analytical column was connected to a high pressure tee through the 6-port valve. A high voltage reed relay was used to switch the electrospray ionization (ESI) voltage between two liquid chromatography channels.

To evaluate the performance difference between conventional constant-flow elution liquid chromatography and the disclosed embodiments system, a 2 ng HeLa digest sample was used in both systems with a 60-minute gradient. The disclosed embodiments system generated the gradient in 15 minutes.

Results from chromatograms showed most peaks align very well between them. A few late peaks (e.g., m/z=655.85) eluted earlier with the disclosed embodiments system, which may be caused by increased flow rate when lower viscosity portions (higher than 50% solvent B) of the gradient enter the column. Proteome Discoverer software identified 2570 and 2330 proteins on average (n=2) for the constant-pressure mode and conventional constant flow system, which indicate that the ability of the two systems to separate a complex biological mixture is similar.

Additionally, another experiment to check the effect of gradient generation speed on the separation was performed. The gradient generation speed was set at two times (75 nL/min), four times (150 nL/min), and eight times (300 nL/min) of elution speed (37 nL/min). The three conditions produced very similar chromatograms with the number of identified proteins being 2590, 2582, and 2582 proteins (n=1).

The results illustrate that different gradient generation speeds do not have a significant impact on separation efficiency, which indicates that either the current liquid chromatography system can generate very fine gradients or there is enough diffusion happening during storage or separation to smooth a coarser gradient.

Lastly, a 10-minute gradient that was generated in 2.5 minutes was utilized to explore the possibility of a short gradient. The results clearly show that the disclosed embodiments can generate a liquid chromatography gradient at a much faster speed while maintaining similar separation performance.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Accordingly, the present invention can be described in terms of one or more alternative aspects and configurations. For example, in a first aspect, a high-duty-cycle liquid chromatography system, can include: two or more columns that are configured to alternatingly be in a productive phase or a regeneration phase, wherein simultaneously one of the two or more columns is in a productive phase and one or more of the two or more columns are in the regeneration phase; a single mobile phase gradient delivery pump; a single isocratic pump; two or more gradient storage chambers; and two or more valves that are each independently coupled to one of the two or more columns and one of the two or more gradient storage chambers, wherein each valve is configured to alternately connect one of the two or more gradient storage chambers to one of the two or more columns while simultaneously enabling storage of solvent via one or more of the two or more gradient storage chambers; wherein: when the column is in the productive phase, the coupled valve connects the one of the two or more gradient storage chambers to the column, wherein the column is configured to deliver analyte to a detector; when the column is in the regeneration phase, the single mobile phase gradient delivery pump is configured to selectively provide a mobile phase gradient and a sample to the two or more gradient storage chambers undergoing regeneration, wherein the mobile phase gradient comprises mobile phase A solvent and mobile phase B solvent; and the isocratic pump is configured to push a mobile phase A solvent through each of the two or more columns at the same time.

In a second aspect, the high-duty-cycle liquid chromatography system as recited in the first aspect, the mobile phase A solution comprises an aqueous solvent and mobile phase B solution comprises an organic solvent.

In a third aspect, the high-duty-cycle liquid chromatography system as recited in any of the first through second aspects, the mobile phase delivery pump may comprise a binary pump configured to increase solvent strength by gradually increasing the composition of solvent from mobile phase A to mobile phase B.

In a fourth aspect, the high-duty-cycle liquid chromatography system as recited in any of the first through third aspects, the mobile phase delivery pump is configured to produce a gradient of increasing solvent strength from three or more solvents.

In a fifth aspect, the high-duty-cycle liquid chromatography system as recited in any of the first through fourth aspects, the system further comprising a trapping column that may be positioned in the flow path between the mobile phase delivery pump and the two or more gradient storage chambers.

In a sixth aspect, the high-duty-cycle liquid chromatography system as recited in any of the first through fifth aspects, the system is configured to avoid delivery of insoluble debris or unwanted chemical species to the column delivering analyte to the mass spectrometer.

In a seventh aspect, the high-duty-cycle liquid chromatography system as recited in any of the first through sixth aspects, the system is configured to selectively deliver waste directly into a waste receptacle thereby avoiding pushing the waste into the column delivering analyte.

In an eighth aspect, the high-duty-cycle liquid chromatography system as recited in any of the first through seventh aspects, the system is configured to provide a duty cycle of greater than 80%.

In a ninth aspect, the high-duty-cycle liquid chromatography system as recited in any of the first through eighth aspects, the system is configured to provide a duty cycle of greater than 90%.

In a tenth aspect, the high-duty-cycle liquid chromatography system as recited in any of the first through ninth aspects, the system is configured to provide a duty cycle of greater than 95%.

In an eleventh aspect, the high-duty-cycle liquid chromatography system as recited in any of the first through tenth aspects, the mobile phase passes through each of the two or more columns at a flow rate of less than 300 nL/min.

In a twelfth aspect, the high-duty-cycle liquid chromatography system as recited in any of the first through eleventh aspects, the mobile phase passes through each of the two or more columns at a flow rate of less than 200 nL/min.

In a thirteenth aspect, the high-duty-cycle liquid chromatography system as recited in any of the first through twelfth aspects, the mobile phase passes through each of the two or more columns at a flow rate of less than 100 nL/min.

In a fourteenth aspect, the high-duty-cycle liquid chromatography system as recited in any of the first through thirteenth aspects, the mobile phase passes through each of the two or more columns at a flow rate of less than 50 nL/min.

In a fifteenth aspect, the high-duty-cycle liquid chromatography system as recited in any of the first through fourteenth aspects, the mobile phase passes through each of the two or more columns at a flow rate of less than 25 nL/min.

In a sixteenth aspect, the high-duty-cycle liquid chromatography system as recited in any of the first through fifteenth aspects, wherein samples are analyzed at a rate of more than 1 sample per hour.

In a seventeenth aspect, the high-duty-cycle liquid chromatography system as recited in any of the first through sixteenth aspects, wherein samples are analyzed at a rate of more than 10 samples per hour.

In an eighteenth aspect, the high-duty-cycle liquid chromatography system as recited in any of the first through seventeenth aspects, the one or more gradient storage chambers comprise a narrow length of tubing having an internal diameter at least 100 times smaller than the tubing length.

In a nineteenth aspect, the high-duty-cycle liquid chromatography system as recited in any of the first through eighteenth aspects, the total number of valves in the system is one more than the total number of columns.

In a twentieth aspect, the high-duty-cycle liquid chromatography system as recited in any of the first through nineteenth aspects, the mobile phase gradient delivery pump operates at a greater flow rate than the flow rate of mobile phase passing through each of the one or more columns.

In a twenty-first aspect, a method of using a high-duty-cycle liquid chromatography system can include: obtaining a sample; moving a valve to couple a mobile phase gradient delivery pump and a gradient storage chamber; pumping, by the mobile phase gradient delivery pump, a mobile phase gradient and the sample to the gradient storage chamber via the valve; pumping, by an isocratic pump, a mobile phase A through a column to a waste area; once the mobile phase gradient and the sample are entirely pumped into the mobile phase gradient, moving the valve to couple the column with the gradient storage chamber; applying a voltage to the column configured to couple the column to a detector; pushing the mobile phase gradient and the sample through the column by pumping, by the isocratic pump, the mobile phase A through the column to the detector; analyzing the sample by the detector.

In a twenty-second aspect, the method as recited in the twenty-first aspect, analyzing identifies at least 1,000 unique species.

In a twenty-third aspect, the method as recited in any of the twenty-first through twenty-second aspects, analyzing identifies at least 3,000 unique species.

In a twenty-fourth aspect, the method as recited in any of the twenty-first through twenty-third aspects, analyzing identifies at least 5,000 unique species.

In a twenty-fifth aspect, the method as recited in any of the twenty-first through twenty-fourth aspects, the unique species comprises at least one of proteins or fragments thereof, lipids, or metabolites.

In a twenty-sixth aspect, the method as recited in any of the twenty-first through twenty-fifth aspects, the detector may comprise a mass spectrometer.

In a twenty-seventh aspect, the method as recited in any of the twenty-first through twenty-sixth aspects, the detector may comprise an optical detector.

In a twenty-eight aspect, the method as recited in any of the twenty-first through twenty-seventh aspects, the sample may comprise a biological sample that includes at least one of tissues, biopsies, cell homogenates, cell fractions, cultured cells, non-cultured cells, whole blood, plasma, biological fluids, or single cells.

In a twenty-ninth aspect, A high-duty-cycle liquid chromatography computing system having a processor, a memory, and a storage having stored thereon computer-executable instructions that are structured such that, when the computer-executable instructions are executed by the processor, cause the liquid chromatography system to perform the following: identify a column to undergo a regeneration phase; move a valve to couple a gradient storage chamber with a mobile phase gradient delivery pump; identify the gradient storage chamber contains a sample solution; move the valve to couple the gradient storage chamber with the column; and identify the sample solution has moved from the gradient storage chamber to the column.

The present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A high-duty-cycle liquid chromatography system, comprising:
two or more columns that are configured to alternatingly be in a productive phase or a regeneration phase, wherein simultaneously one of the two or more columns is in a productive phase and one or more of the two or more columns are in the regeneration phase;
a single mobile phase gradient delivery pump;
a single isocratic pump;
two or more gradient storage chambers; and
two or more valves that are each independently coupled to one of the two or more columns and one of the two or more gradient storage chambers, wherein each valve is configured to alternately connect one of the two or more gradient storage chambers to one of the two or more columns while simultaneously enabling storage of solvent via one or more of the two or more gradient storage chambers.
wherein:
when the column is in the productive phase, the coupled valve connects the one of the two or more gradient storage chambers to the column, wherein the column is configured to deliver analyte to a detector;
when the column is in the regeneration phase, the single mobile phase gradient delivery pump is configured to selectively provide a mobile phase gradient and a sample to the two or more gradient storage chambers undergoing regeneration, wherein the mobile phase gradient comprises mobile phase A solvent and mobile phase B solvent; and
the isocratic pump is configured to push a solvent through each of the two or more columns at a same time.

2. The high-duty-cycle liquid chromatography system as recited in claim 1,
wherein the mobile phase A solvent comprises an aqueous solvent and mobile phase B solution comprises an organic solvent.

3. The high-duty-cycle liquid chromatography system as recited in claim 1, wherein the mobile phase delivery pump is a binary pump configured to increase solvent strength by gradually increasing a composition of solvent from mobile phase A solvent to mobile phase B solvent.

4. The high-duty-cycle liquid chromatography system as recited in claim 1, wherein the mobile phase delivery pump is configured to produce a gradient of increasing solvent strength from three or more solvents.

5. The high-duty-cycle liquid chromatography system as recited in claim 1, further comprising a trapping column that may positioned in a flow path between the mobile phase delivery pump and the two or more gradient storage chambers.

6. The high-duty-cycle liquid chromatography system as recited in claim 1, wherein the system is configured to avoid delivery of insoluble debris or unwanted chemical species to the column delivering analyte to the detector.

7. The high-duty-cycle liquid chromatography system as recited in claim 1, wherein the system is configured to selectively deliver waste directly into a waste receptacle thereby avoiding pushing the waste into the column delivering analyte.

8. The high-duty-cycle liquid chromatography system as recited in claim 1, wherein the system is configured to provide a duty cycle of greater than 80%.

9. The high-duty-cycle liquid chromatography system as recited in claim 1, wherein the mobile phase passes through each of the two or more columns at a flow rate of less than 300 μL/min.

10. The high-duty-cycle liquid chromatography system as recited in claim 1, wherein samples are analyzed at a rate of more than 1 sample per hour.

11. The high-duty-cycle liquid chromatography system as recited in claim 1, wherein the one or more gradient storage chambers comprise a narrow length of tubing having an internal diameter at least 100 times smaller than the tubing length.

12. The high-duty-cycle liquid chromatography system as recited in claim 1, wherein a total number of valves in the system is one more than a total number of columns.

13. The high-duty-cycle liquid chromatography system as recited in claim 1, wherein the mobile phase gradient delivery pump operates at a greater flow rate than the flow rate of mobile phase passing through each of the one or more columns.

14. A method of using a high-duty-cycle liquid chromatography system, comprising:
obtaining a sample;
moving a valve to couple a mobile phase gradient delivery pump and a gradient storage chamber;
pumping, by the mobile phase gradient delivery pump, a mobile phase gradient and the sample to the gradient storage chamber via the valve;
pumping, by an isocratic pump, a mobile phase A solvent through a column to a waste area;
once the mobile phase gradient and the sample are entirely pumped into the gradient storage chamber, moving the valve to couple the column with the gradient storage chamber;
applying a voltage to the column configured to couple the column to a detector;
pushing the mobile phase gradient and the sample through the column by pumping, by the isocratic pump, the mobile phase A solvent through the column to the detector; and
analyzing the sample by the detector.

15. The method of claim 14, wherein analyzing identifies at least 1,000 unique species.

16. The method of claim 15, wherein the unique species comprises at least one of proteins or fragments thereof, lipids, or metabolites.

17. The method of claim 14, wherein the detector is a mass spectrometer.

18. The method of claim 14, wherein the detector is an optical detector.

19. The method of claim 14, wherein the sample is a biological sample that includes at least one of tissues, biopsies, cell homogenates, cell fractions, cultured cells, non-cultured cells, whole blood, plasma, biological fluids, or single cells.

20. A high-duty-cycle liquid chromatography computing system having a processor, a memory, and a storage having stored thereon computer-executable instructions that are structured such that, when the computer-executable instructions are executed by the processor, cause the liquid chromatography system to perform the following:
identify a column to undergo a regeneration phase;
move a valve to couple a gradient storage chamber with a mobile phase gradient delivery pump;
identify that the gradient storage chamber contains a sample and a mobile phase gradient;
move the valve to couple the gradient storage chamber with the column; and
identify the sample and the mobile phase gradient have moved from the gradient storage chamber to the column.
